(19) United States
(12) Patent Application Publication
(10) Pub. No.: US 2009/0154036 A1
(43) Pub. Date: Jun. 18, 2009

(54) Electrostatic discharge circuit

(75) Inventor: Wen Dong Yen, Chu Pei City (TW)

Correspondence Address: Joe McKinney Muncy, PO Box 1364, Fairfax, VA, 22038-1364, US

(73) Assignee: SILICON INTEGRATED SYSTEMS CORP.

(21) Appl. No.: 12/000,541

(22) Filed: Dec. 13, 2007

(51) Int. Cl. H02H 9/04

(52) U.S. Cl. 361/56

(57) ABSTRACT

The invention discloses an electrostatic discharge circuit. The spirit of the invention is that the electrostatic common portion in the conventional integrated circuit is divided into at least two sets corresponding to at least two internal common voltages, separately. In addition, the electrostatic common portions use serily connected diode rings. Therefore, the number of diodes of the diode rings coupling to the higher common voltage and the electrostatic common portion, coupling to the higher common voltage, can be reduced.

### BACKGROUND OF THE INVENTION

(a) Field of the Invention

The invention relates to electrostatic discharge technology, and more particularly to an electrostatic discharge circuit to reduce the IC layout area.

(b) Description of the Related Art

In the integrated circuit (IC) fabrication or after chip fabrication, electrostatic discharge (hereinafter referred to as ESD) occurrence usually is the major cause in the IC damage. For example, about several hundreds up to several thousands volts of static electricity can be detected at the high relative humidity (RH) while a human being is walking through a carpet. At the low relative humidity, about ten thousands volts of static electricity can be detected. The IC packaging machine or the IC testing equipment may generate about several hundreds up to several thousands volts of static electricity due to weather or humidity.

When these charged bodies touch chips, they discharge to these chips to thereby cause IC failure in the chips. Therefore, in order to prevent from damaging ICs in the chip caused by electrostatic discharge, various electrostatic discharge prevention methods are developed. The most common seen method uses hardware to prevent electrostatic discharge. FIG. 1 shows a schematic diagram illustrating an electrostatic discharge circuit in the prior art. Each of the common voltage portions Vdd1 and Vdd2 is coupling to the electrostatic common portion ESD_GND via the diode ring R1 and R2, respectively. Because of the voltage difference between Vdd1 and Vdd2, the number of diodes connected in series for the diode ring R1 is different from that for the diode ring R2. For example, as Vdd1=3.3V and Vdd2=1.5V, in order to have the IC normally operate without discharging to the electrostatic common portion ESD_GND via the diode ring R1 and R2, the forward diode string 101 of the diode ring R1 needs 5 diodes while the forward diode string 102 of the diode ring R2 needs only one diode.

However, as the voltage difference between Vdd1 and Vdd2 becomes larger, more diodes connected in series for the diode rings R1 and R2 are needed. Thus, this causes the layout area of the IC to increase and the cost of the IC fabrication is increased as well.

### BRIEF SUMMARY OF THE INVENTION

In light of the above-mentioned problem, one object of the invention is to provide an electrostatic discharge circuit to reduce the number of elements.

One object of the invention is to provide an electrostatic discharge circuit to reduce the area of the IC layout and the fabrication cost.

In order to achieve the above objects, the invention provides an electrostatic discharge circuit, comprising at least one first common voltage portion, at least one second common voltage portion, a first electrostatic common portion, at least one first diode ring, a second electrostatic common portion, at least one second diode ring, and a third diode ring.

The first common voltage portion is used to couple to a circuit that utilizes a first voltage level. The second common voltage portion is used to couple to a circuit that utilizes a second voltage level. The first electrostatic common portion provides a discharge path. The first diode ring has one terminal coupling to the first electrostatic common portion and the other terminal coupling to the first common voltage portion. The second electrostatic common portion provides another discharge path. The second diode ring has one terminal coupling to the second electrostatic common portion and the other terminal coupling to the second common voltage portion. The third diode ring has one terminal coupling to the first electrostatic common portion and the other terminal coupling to the second electrostatic common portion.

The spirit of the invention is that the electrostatic common portion in the conventional integrated circuit is divided into at least two sets of electrostatic common portions corresponding to at least two internal common voltages, separately. In addition, the electrostatic common portions use serily connected diode rings. Therefore, the number of diodes of the diode rings coupling to the higher common voltage and the electrostatic common portion, coupling to the higher common voltage, can be reduced.

In order to illustrate the objects, characteristics, and advantages of the invention, the preferred embodiments of the invention together with figures are described and shown in the following.

### BRIEF DESCRIPTION OF THE DRAWINGS

FIG. 1 shows a schematic diagram illustrating an electrostatic discharge circuit in the prior art.

FIG. 2 shows a schematic diagram illustrating the circuit block diagram of the semiconductor integrated circuit according to one embodiment of the invention.

FIG. 3 shows a schematic diagram illustrating an electrostatic discharge circuit 201 according to one embodiment of the invention.

### DETAILED DESCRIPTION OF THE INVENTION

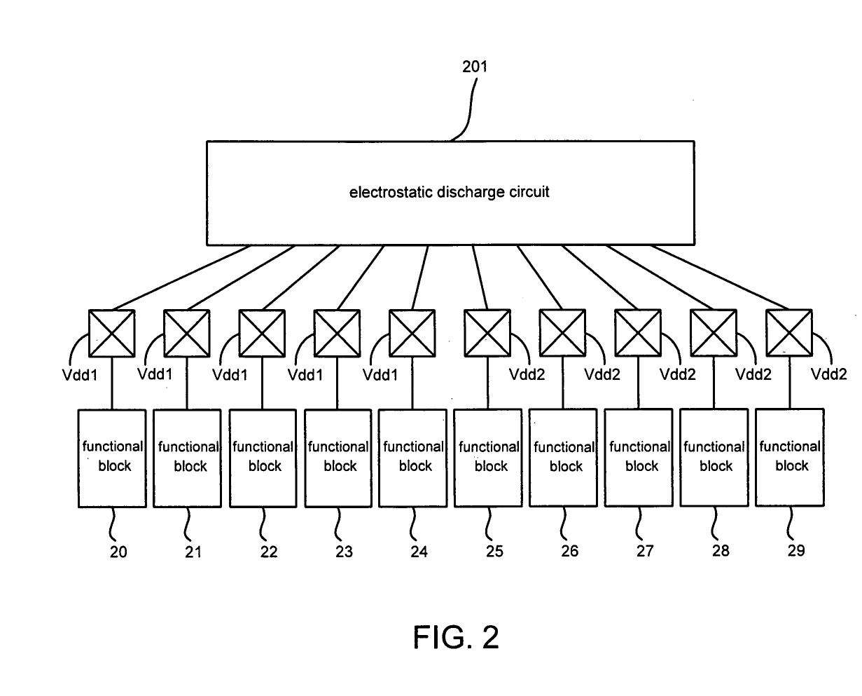

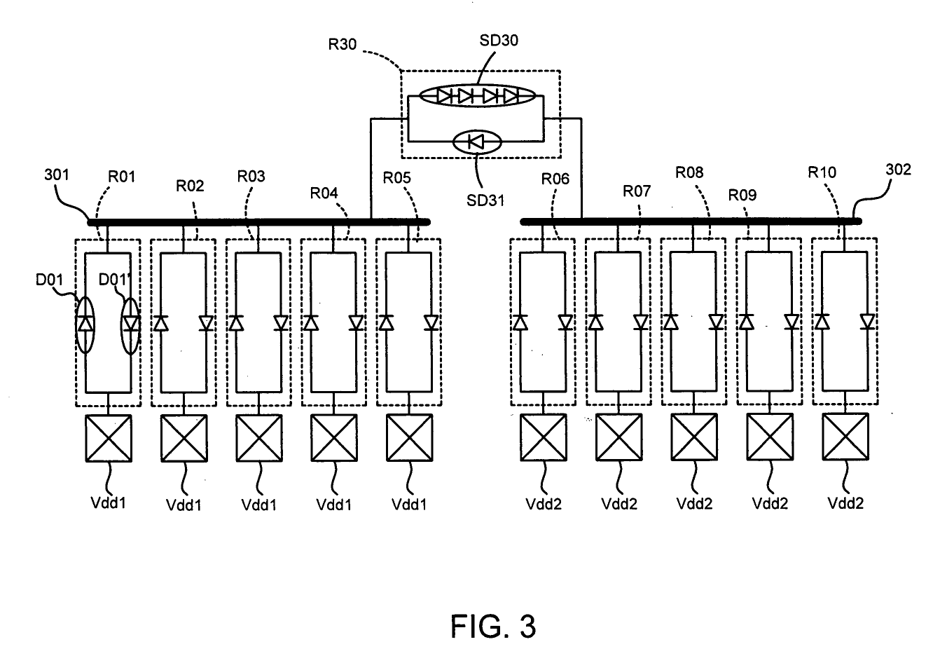

FIG. 2 shows a schematic diagram illustrating the circuit block diagram of the semiconductor integrated circuit according to one embodiment of the invention. As shown in FIG. 2, the integrated circuit comprises 10 functional blocks 20˜29, a 3.3V common voltage portion Vdd1, a 1.2V common voltage portion Vdd2, and an electrostatic discharge circuit 201. FIG. 3 shows a schematic diagram illustrating the electrostatic discharge circuit 201 according to one embodiment of the invention. Referring to FIG. 3, for clarity, the common voltage portions Vdd1 and Vdd2 are still drawn in the figure. The electrostatic discharge circuit 201 comprises 10 diode rings R01˜R10, an electrostatic common portion 301 corresponding to Vdd1, an electrostatic common portion 302 corresponding to Vdd2, and a diode ring R30 connecting the electrostatic common portion 301 and the electrostatic common portion 302. The diode ring R30 comprises a diode string SD31 and a diode string SD30. The diode string SD31 comprises m (m is positive integer) diodes connected in series and has a first terminal coupling to the electrostatic common portion 301 and a second terminal coupling to the electrostatic common portion 302. The diode string SD30 comprises n (n is positive integer) diodes connected in series and has a first terminal coupling to the electrostatic common portion 302 and a second terminal coupling to the electrostatic common portion 301. Wherein, the n and m are determined by the voltage difference between the common voltage portion Vdd1 and the common voltage portion Vdd2.

The coupling relationship of the electrostatic discharge circuit and the elements of the semiconductor integrated circuit are shown in FIGS. 2 and 3.

If the positive ESD to the common voltage portion corresponding to the functional block 20 is occurred, the diode D01 in the diode ring R01 turns on immediately and the diode string SD30 of the diode ring R30 also turns on. Therefore, the positive ESD shock is directed to the electrostatic common portion 302 via the diode D01, the electrostatic common portion 301, and the diode string SD30. Thus, the functional block 20 can be protected. On the other hand, if the negative ESD to the common voltage portion corresponding to the functional block 20 is occurred, the negative ESD is directed to the electrostatic common portions 301 and 302 via the diode D01′ on the other side of the diode ring R01 and the diode string SD31 on the other side of the diode ring R30.

Since the IC cannot discharge to the electrostatic common portion 302 via the diode rings R01˜R10 and R30, the cascade number of diodes to the electrostatic common portions 302 has to be larger than a preset value. Since the common voltage Vdd1 is 3.3V and Vdd2 is 1.2V, the cascade number of diodes in this embodiment is five. Thus, in this embodiment the diode ring R30 is shared to have the cascade number become 5. Therefore, the total usage of diodes is reduced. By comparing this embodiment of the invention with the prior art, it is found that the total diodes in use for the electrostatic discharge circuit in the prior art are 40 but 25 diodes are used in the electrostatic discharge circuit according to this embodiment of the invention. Obviously, this embodiment reduces the usage of diodes. Since the number of elements is reduced, the area of the IC layout and the cost are also reduced.

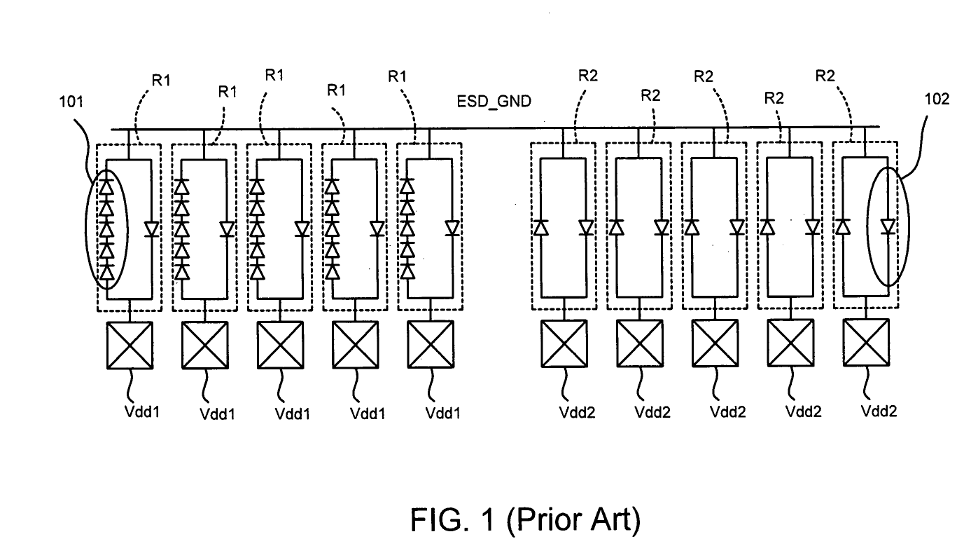

For example, the current chip applicable to the invention requires 18 sets of 1.2V power sources and 23 sets of 3.3V power sources. If the ESD circuit in the prior art is in use, the pads of 23 sets of 3.3V power sources have to be connected to the diode rings R1, having 5:1 allocation shown in FIG. 1, and thus the diode ring area is 320 μm×90 μm. On the other hand, if the ESD circuit according to the invention is in use, the pads of 23 sets of 3.3V power sources have to be connected to the diode rings R1, having 1:1 allocation shown in FIG. 3, and thus the diode ring area is 160 μm×90 μm. The total area for the current chip is 7380 μm×7380 μm=54,464,400 μm². Thus, the area spared by applying the implement of the invention is [(320 μm−160 μm)×90 μm]×23 sets=331,200 μm². Therefore, the ratio of the spared area to the total area of the chip is (331,200 μm²)/(54,464,400 μm²)=0.006081=0.61%.

Although the present invention has been fully described by the above embodiments, the embodiments should not constitute the limitation of the scope of the invention. Various modifications or changes can be made by those who are skilled in the art without deviating from the spirit of the invention.

What is claimed is:

1. An electrostatic discharge circuit, comprising:
at least one first common voltage portion for coupling to a circuit that utilizes a first voltage level;
at least one second common voltage portion for coupling to a circuit that utilizes a second voltage level;
a first electrostatic common portion for providing a discharge path;
at least one first diode ring having one terminal coupling to the first electrostatic common portion and the other terminal coupling to the first common voltage portion;
a second electrostatic common portion for providing another discharge path;
at least one second diode ring having one terminal coupling to the second electrostatic common portion and the other terminal coupling to the second common voltage portion; and
a third diode ring having one terminal coupling to the first electrostatic common portion and the other terminal coupling to the second electrostatic common portion.

2. The electrostatic discharge circuit according to claim 1, wherein the first diode ring comprises:
a first diode having a first terminal coupling to the first electrostatic common portion and a second terminal coupling to the first common voltage portion; and
a second diode having a first terminal coupling to the second terminal of the first diode and a second terminal coupling to the first terminal of the first diode.

3. The electrostatic discharge circuit according to claim 1, wherein the second diode ring comprises:
a third diode having a first terminal coupling to the second electrostatic common portion and a second terminal coupling to the second common voltage portion; and
a fourth diode having a first terminal coupling to the second terminal of the third diode and a second terminal coupling to the first terminal of the third diode.

4. The electrostatic discharge circuit according to claim 1, wherein the third diode ring comprises:
a first diode string comprising m (m is positive integer) diodes connected in series and having a first terminal coupling to the first electrostatic common portion and a second terminal coupling to the second electrostatic common portion; and
a second diode string comprising n (n is positive integer) diodes connected in series and having a first terminal coupling to the second electrostatic common portion and a second terminal coupling to the first electrostatic common portion in which n and m are determined by the voltage difference between the first common voltage portion and the second common voltage portion.

5. The electrostatic discharge circuit according to claim 2, wherein the first terminal of the diode is a cathode and the second terminal of the diode is an anode.

6. The electrostatic discharge circuit according to claim 3, wherein the first terminal of the diode is a cathode and the second terminal of the diode is an anode.

7. The electrostatic discharge circuit according to claim 4, wherein the first terminals of the first diode string and the second diode string are cathodes of diodes and the second terminals are anodes.
